(19) United States
(12) Patent Application Publication
(10) Pub. No.: US 2015/0252941 A1
(43) Pub. Date: Sep. 10, 2015

(54) POST CONNECTING BRACKET FOR ORNAMENTAL FENCES

(71) Applicant: SATELLITE METAL INC., St. Laurent (CA)

(72) Inventor: Howard SIRKIN, Laval (CA)

(73) Assignee: SATELLITE METAL INC., St. Laurent (CA)

(21) Appl. No.: 14/198,838

(22) Filed: Mar. 6, 2014

(51) Int. Cl. F16M 13/02; F16L 3/12

(52) U.S. Cl. CPC F16M 13/022; F16L 3/1207

(57) ABSTRACT

A post connecting bracket for ornamental fences is comprised by a hollow post embracing section defined by a pair of spaced-apart parallel side was and an interconnecting and wall. A projecting tube connecting formation extends from the hollow post embracing section to support pre-formed fence sections. The hollow post embracing section has adjustable bracket connections for removably attaching thereto a swivel attachment bracket. The swivel attachment bracket is securable to any of the pair of spaced-apart parallel side walls and the interconnecting and wall and positionable at three vertical positions.

### TECHNICAL FIELD

The present invention relates to a post connecting bracket for ornamental fences and more particularly to such a post connecting bracket wherein a swivel attachment bracket can be secured to different walls of a hollow post embracing section of the post connecting bracket and at different vertical positions.

### PRIOR ART

Known post connecting brackets for ornamental fences are usually comprised of various bracket formations which are interconnected together by bolts, often these bolts being of different sizes for the different types of brackets. Ornamental fences are comprised of vertical post to which brackets are secured whereby to support pre-formed fence sections therebetween. Known types of brackets are comprised of a U shaped clamp bracket section to which is secured, or formed integral therewith, a projecting tube connecting formation. When assembled to oppose sides of a post, the projecting tube connection formation of the bracket sections extends transverse to the post. These posts are usually of square cross-section. To secure the pre-formed fence sections two of these U-shaped clamp brackets are connected together by outwardly projecting wings thereof which are bolted together. When secured, the projecting tube connection formation of each U-shaped clamp bracket extends axially aligned on opposed sides of the vertical post. If the fence sections terminate at a corner post, that does not have a 90° range, then a different type U-shape bracket is required which does not have a projecting tube connecting formation. If a pre-formed fence section is to be secured transversely to an end post that is not 90°, then different type brackets need to be secured one on top of the other so that the pre-formed fence sections lie in a common horizontal plane.

Another disadvantage of the prior art is that when constructing these ornamental fences over slopping terrain where the pre-formed fence sections have to be disposed at different horizontal level with respect to the support post, then an additional bracket is required to be mounted under the existing bracket supporting a pre-formed fence section at a higher level, thus creating a step ornamental fence.

Still, if a swing gate or swing fence section is to be secured to a post, a gate support bracket equipped with a vertical pin or pin receiving tongues is provided. These brackets are secured to both the post and the fence section at a different level under the existing brackets secured to the corner post. Again these swivel brackets require different fasteners. Thus, it can be seen that existing ornamental fence constructions require various types of connecting brackets and fasteners and therefore requiring a large inventory of parts and further adding to the cost of the construction of such ornamental fences. Additional problems can be caused when one of these different type brackets is damage or lost or there are insufficient attachment fasteners.

### SUMMARY OF THE INVENTION

It is a feature of the present invention to provide the post connecting bracket for ornamental fences and which substantially overcomes the above-mentioned disadvantages of the prior art.

Another feature of the present invention is to provide a post connecting bracket for ornamental fences and wherein the connecting bracket has a universal function and requires a single fastener for securing the bracket and a pre-formed fence section to a vertical post.

Another feature of the present invention is to provide a post connecting bracket capable of securing pre-formed fence sections at the same height or different heights on opposed sides of a vertical post by securing two of these post connection brackets one on top of the other in a common position or in a reverse position.

Another feature of the present invention is to provide a post connecting bracket to which is removably securable a swivel attachment bracket for securing a swing gate thereto.

Another feature of the present invention is to provide a post connecting bracket for ornamental fences and wherein the bracket is integrally formed from sheet metal.

Another feature of the present invention is to provide the post connecting bracket for ornamental fences and which bracket comprises a hollow post embracing section having a pair of spaced-apart parallel side walls and an interconnecting end wall, each of which are provided with adjustable swivel bracket connecting means for attaching a swivel attachment bracket to any of the walls and at three different vertical positions on each of the walls.

According to the above features, from a broad aspect, the present invention provides a post connecting bracket for ornamental fences, and wherein the bracket defines a hollow post embracing section comprised by a pair of spaced-apart parallel side walls and an interconnecting end wall. A projecting tube connecting formation extends from the spaced-apart parallel side walls and projects from an end thereof opposed to the transverse interconnecting end wall. A swivel attachment bracket is also provided and has parallel tongues projecting from a transverse connecting wall, At least one side wall of the pair of spaced-apart parallel side walls and the transverse interconnecting end wall has adjustable swivel bracket connecting means for attaching the swivel attachment bracket thereto at at least two different height positions with the parallel tongues extending outwardly in horizontal planes from the at least one wall of the said pair of spaced-apart parallel side walls and the is interconnecting end wall.

According to a further broad aspect of the present invention, the adjustable bracket connecting means is comprised by an outwardly recess wall portion extending outwardly of the side walls of the pair of spaced-apart parallel side walls and the interconnecting end wall. Also, a straight horizontal slot of predetermined length is formed in the recess wall portions of the spaced-apart parallel side walls and the transverse interconnecting end wall. A retention groove is formed in at least one of an upper or lower edge of the side walls or end wall and disposed in vertical alignment with the horizontal slot.

### DESCRIPTION OF THE DRAWINGS

A preferred embodiment of the present invention will now be described with reference to the accompanying drawings, in which:

FIG. 1 is a perspective view of the post connecting bracket of the present invention shown positioned about a vertical post;

FIG. 2 is a perspective view similar to FIG. 1 but showing a swivel attachment bracket removably secured to the post connecting bracket and at a lower connected position;

FIG. 3 is a top view of the post connecting bracket of the present invention;

FIG. 4 is a side view of the post connecting bracket and showing in phantom lines a second bracket disposed in reverse position under the bracket and about a support post illustrated schematically in phantom lines;

FIG. 5 is an end view of the post connecting bracket when seen from the projecting tube connecting formation;

FIG. 6 is an opposed end view as seen from the interconnecting end wall of the post connecting bracket;

FIG. 7 is a perspective view of the swivel attachment bracket;

FIG. 8 is a top view of the swivel attachment bracket of FIG. 7;

FIG. 9 is a side view of the swivel attachment bracket of FIG. 8;

FIGS. 10A to 10C are perspective views showing the swivel attachment bracket secured to the post connecting bracket and to a respective one of the pair of spaced-apart parallel side walls and the interconnecting end wall of the hollow post embracing section thereof; and

FIGS. 11A to 11C are perspective views showing the swivel attachment bracket connected at different height positions to the adjustable swivel bracket connecting means of each of the pairs of spaced-apart parallel side walls and the interconnection end wall.

### BRIEF DESCRIPTION OF THE PREFERRED EMBODIMENT

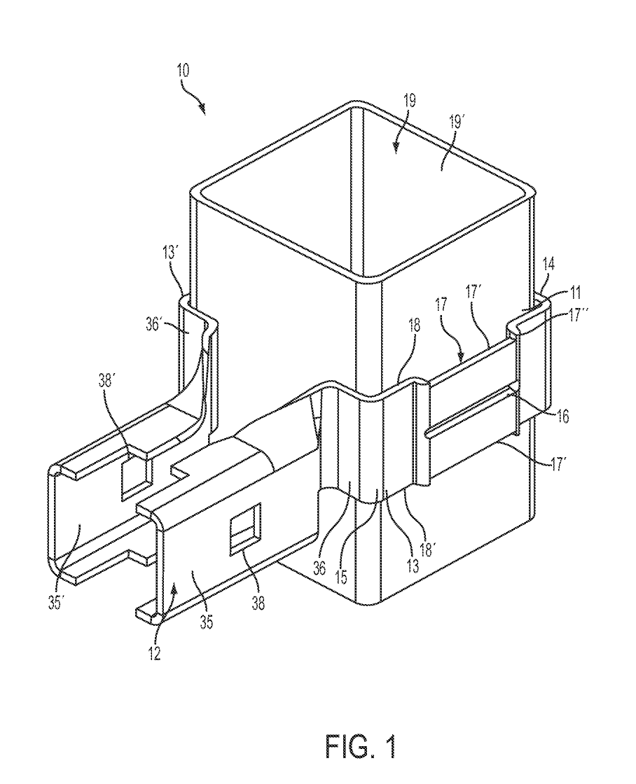

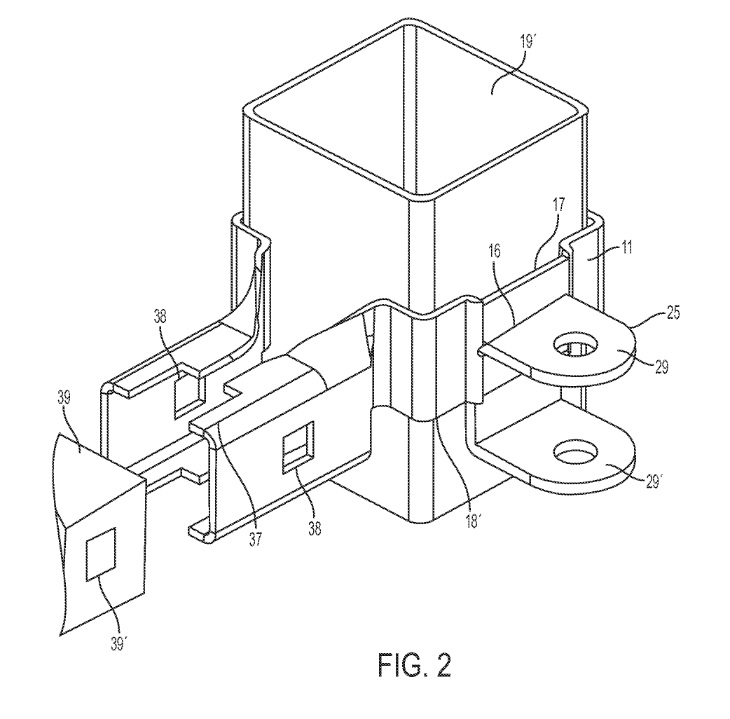

Referring now to the drawings and more particularly to FIGS. 1 and 2, there is shown generally at 10 the post connecting bracket of the present invention for connection to vertical posts 19′ of ornamental fences and for supporting pre-formed fence sections, not shown but obvious to a person skilled in the art, therebetween. The post connecting bracket comprises a hollow post embracing section 11 defined by a pair of spaced-apart parallel side was 13 and 13′ and a transverse interconnecting end wall 14. A projecting tube formation 12 is formed integral and extends from the spaced-apart parallel side walls 13 and 13′ and project from an end of the side was and opposed to the transverse interconnecting end wall 14.

As illustrated in FIG. 2, the pair of spaced-apart parallel side was 13 and 13′ and the interconnecting end wall 14 forming the hollow post embracing section 11, are each provided with adjustable bracket connecting means 17 for attaching a swivel attachment bracket 25, as shown in FIG. 7, thereto. The swivel attachment bracket to 25 is securable to the opposed parallel side walls 13 and 13′ and the interconnecting end wall 14 at at least two different height positions, herein three different height positions as will be described further on.

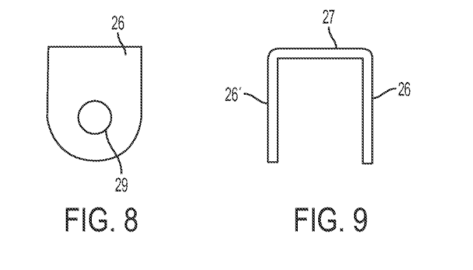

With reference to FIGS. 7 to 9, there is shown the construction of the swivel attachment bracket 25. As hereinshown, the swivel attachment bracket 25 is integrally formed and comprised by a pair of parallel tongues 26 and 26′ extending from opposed ends of a transverse connecting wall 27. The transverse connecting wall 27 is a square connecting wall and the tongues have a curve outer edge 28. The tongues are also each provided with through holes 29 and 29′ respectively and which are vertically aligned with one another.

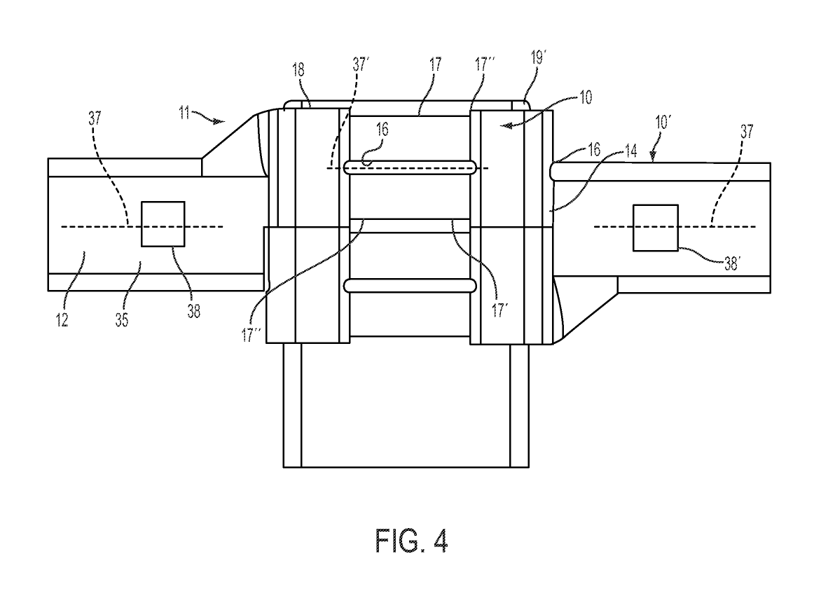

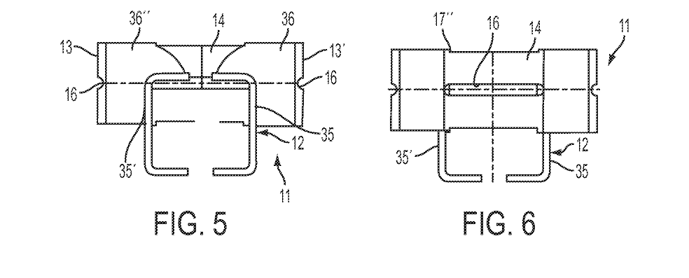

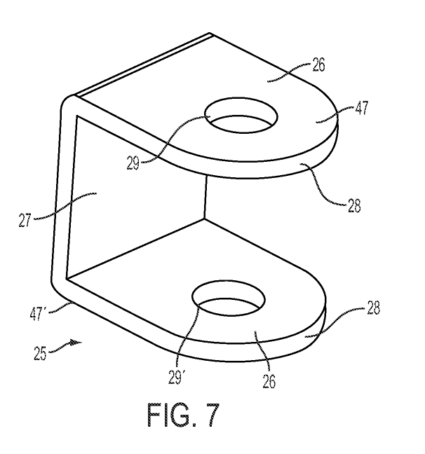

With reference now to FIGS. 1 and 3 to 6, it can be seen that the pair of spaced-apart parallel side walls 13 and 13′ and the interconnecting end wall 14 each have an outwardly recess wall portion 18′″ formed therein and extending outwardly of the side walls and interconnecting end wall a distance to form a gap there behind. The gap has a depth substantially equal to the thickness of the transverse connecting wall 27 of the swivel attachment bracket 25. This recess wall portion 18′″ also has a width which is the same width as the transverse connecting wall 27 whereby to receive the transverse connecting wall 27 in close fit there behind. The recess wall portion 18′″ forms part of the adjustable bracket connecting means 17 as well as the straight horizontal slot 16 formed in the recess wall portion 18′″ of at least one of the spaced-apart parallel side walls and the transverse interconnecting end wall, and preferably as hereinshown as being formed in all of these walls. Each of the side walls 13 and 13′ and the interconnecting end wall 14 have a retention groove formed in at least one of the upper and lower edge thereof, herein edges 18 and 18′ and disposed in vertical alignment with the horizontal slot 16, as dearly illustrated in FIG. 4. As hereinshown, a retention groove is formed in both the upper and lower horizontal edges 18 and 18′ respectively, of each of the pair of opposed parallel side walls 13 and 13′ and the interconnecting end wall 14.

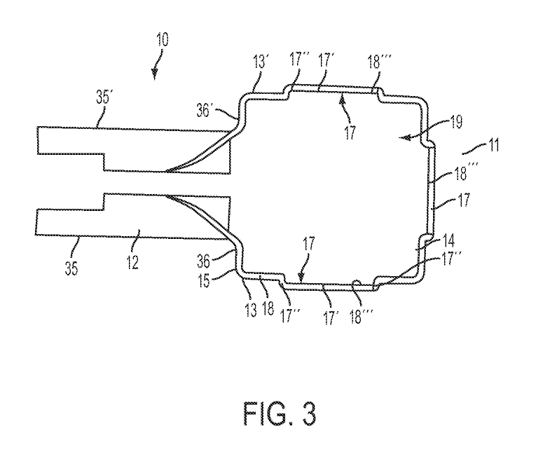

As shown in FIGS. 3 to 6, the pair of spaced-apart parallel side walls 13 and 13′ and the transverse interconnecting end wall 14 are rectangular walls and define therebetween a square rectangular post receiving passage 19 for receiving a square rectangular post, such as the post 19′ illustrated in FIGS. 1 and 2 in close sliding fit lo therein for securing the post connecting bracket 10 to the post 19′. Accordingly, the upper and lower horizontal edges 18 and 18′ are straight parallel edges and the retention grooves have a straight bottom edge 17′ parallel to the upper and lower horizontal edges 18 and 18′. The parallel tongues 26 and 26′ of the swivel attachment bracket 25 are configured to be retained in close fit into the retention grooves 17 and 17′. Also, the parallel tongues 26 and 26′ of the swivel attachment bracket 25 are spaced-apart a distance equal to the distance between the longitudinal straight slot 16 and either one of the retention grooves 17 and 17′. As can be seen the horizontal straight slot 16 is disposed at mid-distance between the upper and lower horizontal edges 18 and 18′.

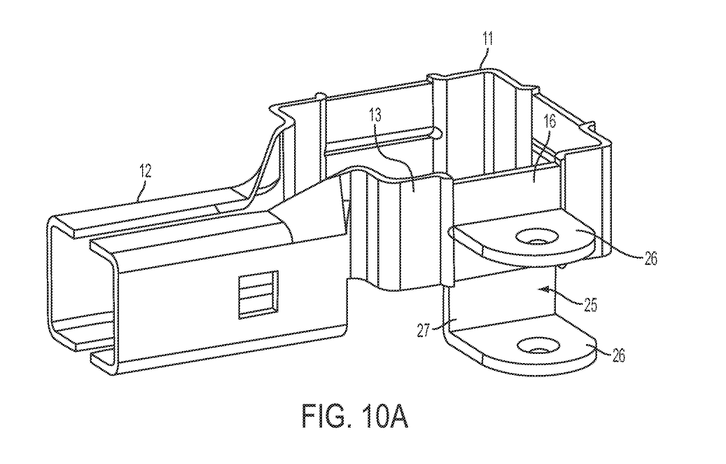

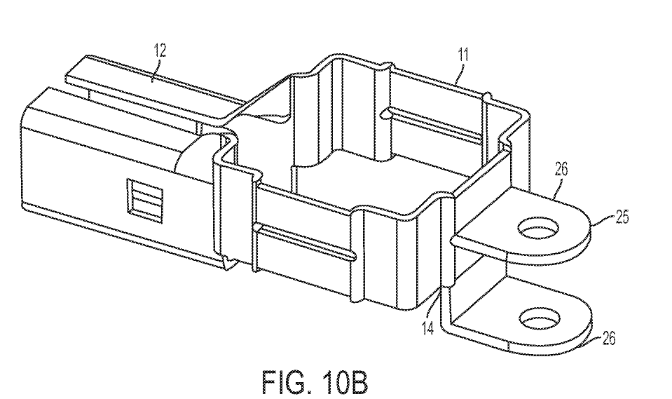

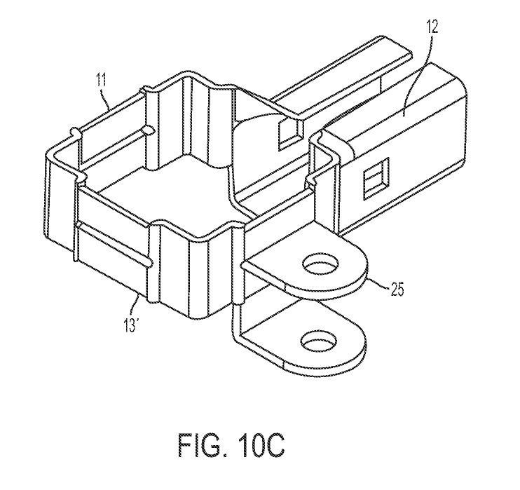

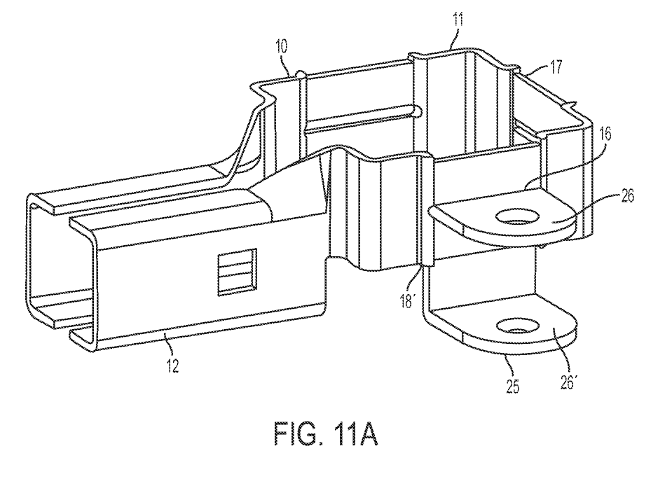

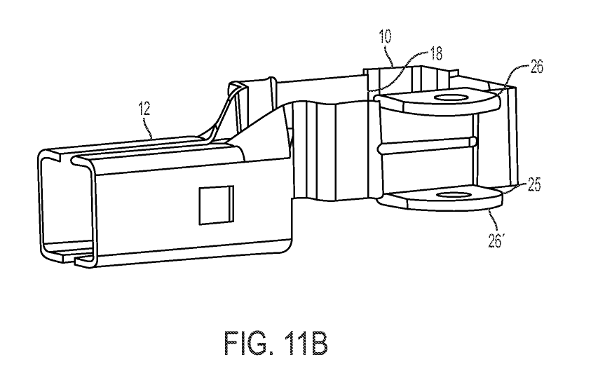

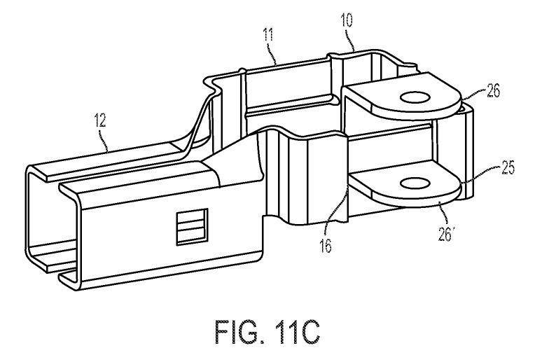

With reference now to FIGS. 10A to 100, it can be seen that the swivel attachment bracket 25 is attachable to anyone of the spaced-apart parallel side walls 13 and 13′ and the interconnecting transverse end wall 14 and at three different height positions as will be described with reference to FIGS. 11A to 110. In FIGS. 10A to 100. The swivel attachment bracket 25 is hereinshown secured at a lower position to each of the parallel side walls and end wall.

With additional reference to FIGS. 11A to 110, it can be seen that the swivel attachment bracket 25 is securable at three different height positions. In FIG. 11A, like FIG. 10A, the swivel attachment bracket is secured to a first height position, herein a lower height position wherein the top tongue 26 of the bracket 25 is disposed within the straight horizontal slot 16 from behind the side wall 13 with the interconnecting wall 27 of the swivel attachment bracket having an upper portion thereof lying within the recess wall portion 18″. Accordingly, when the hollow post embracing section 11 receives the post 19′ therethrough, the swivel bracket 25 becomes immovably retained within the recess wail portion 18′″ to the side wall 13. FIG. 11B shows an intermediate position of the swivel attachment bracket 25 wherein the opposed tongues 26 and 26′ are received respectively in the top and bottom retention grooves 17′. FIG. 11C shows an upper position of the swivel bracket 25 wherein the lower tongue 29′ is disposed within the horizontal slot 16 and a lower portion of the transverse connecting wall 27 of the swivel bracket is captive behind the recess wall portion 18′″.

The swivel attachment bracket of the present invention is formed from metal sheet material, herein steel, which is dye cut and dye formed as a U-shaped bracket

Likewise, the post connecting bracket 10 is dye cut and dye formed from sheet material whereby to form the hollow post embracing section 11 as well as the projecting tube formation 12. The tube formation 12 is formed by two projecting sleeves 35 of U-shaped transverse cross-section which each project from a right angle inwardly extending transverse flange wall section 36 of each of the spaced-apart parallel side walls 13 and 13′. The transverse flange wall sections 36 and 36′ extend substantially parallel to the interconnecting end wall 14. The two projecting sleeves of U-shaped cross-section 35 and 35′ are recessed and spaced-apart in parallel relationship and have a central longitudinal axis 37, see FIG. 4, which extends in a plane which is recessed from the longitudinal axis 3T of the straight horizontal slot 16 which is disposed at mid-distance between the upper and lower horizontal edges 18 and 18′ of the spaced-apart parallel side walls 13 and 13′. The projecting sleeves 35 and 35′ are each provided with a hole 38 therein and transversely align with one another to receive a fastener, usually a bolt, not shown, for clamping a tube end 39, see FIG. 2, of a preformed fence section, not shown but obvious to a person skilled in the art, therebetween. The single fastener which extends through the holes 38 also extend through a hole 39′ formed in opposed walls of the tube end 39 and the projecting sleeves 35 and 35′ are also dimensioned to receive this tube end 39 in loose sliding fit therein. Accordingly, when a bolt fastener is disposed through the holes 38 in the projecting sleeves 35 and 35′ and through the holes 39′ in the tube end section, it clamps the projecting sleeves 35 and 35′ together causing the sleeves to move closer to one another until the sleeves abut the opposed side walls of the tube end section 39 of the preformed fence section, and at the same time applies a clamping force between the pair of spaced-apart parallel side was 13 and 13′ of the bracket to clamp the hollow post section 11 about the vertical post 19′ which projects vertically therein.

With reference to FIG. 4, it can be seen that In order to connect two preformed fence sections on opposed sides of a post 19′, two brackets 10 are secured one on top of the other with the projecting sleeves 12 of one of the post connecting brackets 10 extending either in alignment on opposed sides of a support post to form a continuous straight fence or extending at right angles thereto on a side of either of the parallel side walls 13 and 13′, such as to form a corner of an ornamental fence. As shown in FIG. 4 two of these post connecting brackets 10 and 10′ are secured one on top of each other with one of them 10′ being inverted with respect to the other one whereby the offset longitudinal axis 36 of the projecting sleeves 12 lie in a common horizontal plane. if two of these post connecting brackets are secured one on top of each other in the same orientation, then the axes 37 of the projecting sleeves 12 would be offset from one another such as is required when preformed fence sections are to be secured on opposed sides of a post but at different levels to follow a slope ground surface.

It is within the ambit of the present invention to cover any obvious modifications of the preferred embodiment described herein, provided such improvements fall within the scope of the appended claims.

1. A post connecting bracket for ornamental fences, said bracket comprising a hollow post embracing section defined by a pair of spaced-apart parallel side walls and an interconnecting end wall, a projecting tube connecting formation extending from said spaced-apart parallel side walls and project from a free end thereof transverse to said interconnecting end wall, and a swivel attachment bracket having integrally formed parallel tongues projecting from a transverse connecting wall, at least one side wall of said pair of spaced-apart parallel side walls and said transverse interconnecting end wall having adjustable bracket connecting means for attaching said swivel attachment bracket thereto at at least two different height positions with said parallel tongues extending outwardly in horizontal planes from said at least one side wall of said pair of spaced-apart parallel side walls and said interconnecting end wall.

2. The post connecting bracket as claimed in claim 1 wherein said adjustable bracket connecting means is comprised a recess wall portion extending outwardly of a side wall of said pair of spaced-apart parallel side walls and said interconnecting end wall, a straight horizontal slot of predetermined length formed in said recess wall portion of at least one of said spaced-apart parallel side walls and said transverse interconnecting end wall, and a retention groove formed in at least one of an upper or lower horizontal edge of said spaced-apart parallel side wall or end wall and disposed in vertical alignment with said horizontal slot.

3. The post connecting bracket as claimed in claim 2 wherein said retention groove is formed in both said upper and lower horizontal edges and disposed in vertical alignment with one another and said horizontal slot.

4. The post connecting bracket as claimed in claim 3 wherein said adjustable bracket connecting means is provided in said pair of spaced-apart parallel side walls and said transverse interconnecting end wall.

5. A post connecting bracket as claimed in claim 4 wherein said pair of spaced-apart parallel side walls and said transverse interconnecting end wall are rectangular walls and define therebetween a square rectangular post receiving passage for receiving a square rectangular post in close sliding fit therein for securing said post connecting bracket to said post.

6. The post connecting bracket as claimed in claim 2 wherein said upper and lower horizontal edges are straight parallel edges, said retention groove having a straight bottom edge parallel to said upper and lower horizontal edges and opposed vertical end edges, said parallel tongues of said swivel attachment bracket extending from opposed ends of said transverse connecting wall and configured to be retained in close fit into said retention groove.

7. The post connecting bracket as claimed in claim 6 wherein said parallel tongues of said swivel attachment bracket are spaced apart a distance equal to the distance between said horizontal straight slot and either one of said retention groove, said horizontal straight slot being disposed at mid-distance between said upper and lower horizontal edges.

8. The post connecting bracket as claimed in claim 7 wherein said swivel attachment bracket is attachable to any one of said spaced-apart parallel side walls and said interconnecting end wall at three different height positions, a first height position defined with said transverse connecting wall disposed behind said rectangular wall in said recess wall portion of said spaced-apart parallel side walls or interconnecting end wall, in a first height position; said parallel tongues are disposed in a respective one of said retention grooves, in a second height position; one of said parallel tongues is disposed in said horizontal straight slot, and the other of said parallel tongues is disposed above said top retention groove in a third position.

9. The post connecting bracket as claimed in claim 1 wherein said parallel tongues have a curved outer edge, and a through hole formed in each said parallel tongue and vertically aligned with one another.

10. The post connecting bracket as claimed in claim 1 wherein said post connecting bracket is integrally formed from steel metal sheet.

11. The post connecting bracket as claimed in claim 2 wherein said projecting tube formation is formed by two projecting sleeves of transverse U-shape cross-section projecting from a right angle inwardly transverse flange wall section of each said spaced-apart parallel side walls, said transverse flange wall sections extending substantially parallel to said interconnecting end wall, said two projecting sleeves of transverse U-shape cross-section being spaced apart in parallel relationship and having a central longitudinal axis extending in a plane recessed from a longitudinal axis of said straight horizontal slot, said straight horizontal slot being disposed at mid-distance between said upper and lower horizontal edges of said spaced-apart parallel side walls, said projecting sleeves each having a hole therein transversely aligned with one another to receive a fastener for clamping a tube end section of a preformed fence section therebetween and applying a clamping force between said pair of spaced-apart parallel side walls to clamp onto a vertical post projecting vertically there between.

12. The post connecting bracket as claimed in claim 11 wherein two of said post connecting brackets are secures to said post one on top of the other.

13. The post connecting bracket as claimed in claim 12 wherein one of said two of said post connecting brackets is inverted whereby said recessed projecting tube formation of each post connecting bracket lie in a common plane.
